(19) United States
(12) Patent Application Publication
(10) Pub. No.: US 2012/0122396 A1
(43) Pub. Date: May 17, 2012

(54) METHOD FOR FAST DEVICE SEARCH BASED ON SHORT RANGE COMMUNICATION MODULE AND MOBILE DEVICE FOR SUPPORTING THE METHOD

(75) Inventor: Ki Woong HA, Gyeonggi-do (KR)

(73) Assignee: SAMSUNG ELECTRONICS CO., LTD., Gyeonggi-Do (KR)

(21) Appl. No.: 13/289,113

(22) Filed: Nov. 4, 2011

(30) Foreign Application Priority Data
Nov. 16, 2010 (KR) 10-2010-0113833

(51) Int. Cl. H04B 7/24; H04B 5/00

(52) U.S. Cl. 455/41.1; 455/41.2

(57) ABSTRACT

A method and mobile device for a fast device search based on a short range communication module. In the method, the mobile device checks a setting value of a fast device search mode for a restriction on a communication range of the short range communication module. Then the mobile device restricts transmission power of the short range communication module to a specific magnitude, and searches at least one short range communication device located within a specific range determined by the restricted transmission power. In the case where the short range communication module is a Bluetooth module, a pincode/passkey input can be exchanged to pairing a device with the mobile device within the specific range. A received signal strength indicator (RSSI) may be the basis for automatic selection of a device within the specific range.

### CLAIM OF PRIORITY

This application claims the benefit of priority from Korean Patent Application No. 10-2010-0113833, filed Nov. 16, 2010, the contents of which are incorporated by reference in its entirety.

### BACKGROUND OF THE INVENTION

1. Field of the Invention

The present invention relates in general to a communication channel formation technology based on a short range communication module. More particularly, the present invention relates to a method and mobile device for a fast device search based on a short range communication module in which neighboring devices are rapidly searched through restricted transmission power of the short range communication module and then a communication channel is formed with a desired short range communication device.

2. Description of the Related Art

A conventional mobile device in general refers to a kind of electronic communication device that provides portability while in operation. With the remarkable growth of related technologies, a great variety of mobile devices are now capable of supporting various end-user functions beyond voice or text communication, and such devices are becoming increasingly popular. For example, a mobile device may have a file playback function for playing audio/video files stored therein, a camera function for capturing still images, a video camera function for making video films, an Internet browser and associated functionality, and the like.

Additionally, a conventional mobile device may not only inherently provide a mobile communication function using a base station, but also optionally provide a short range communication function that includes forming a communication channel with any other mobile device located at a close range with a base station as a go between, transmitting and receiving data to and from that device in a peer-to-peer arrangement, or controlling that device. A Bluetooth module is one of representative modules for such a short range communication function.

In order to use a short range communication function, a mobile device should first of all perform a search for neighboring short range communication devices. However, since such a search process is performed for all neighboring short range communication devices, particularly in a public area (train station, arena, etc.) too much search time is required and further a user may usually experience too much inconvenience of selecting a desired short range communication device as there could be a large number of such devices from which to make a selection.

### BRIEF SUMMARY OF THE INVENTION

Accordingly, the present invention overcomes in part at least some of the above-mentioned problems and/or disadvantages and offers at least the advantages described herein below.

An exemplary aspect of the present invention is to provide a method and mobile device for a fast device search based on a short range communication module by allowing a selective search for specific short range communication devices only.

According to one exemplary aspect of the present invention, provided is a method for a fast device search based on a short range communication module in a mobile device, the method comprising: restricting transmission power of the short range communication module to a specific magnitude; and searching at least one short range communication device located within a specific range determined by the restricted transmission power.

According to another exemplary aspect of the present invention, provided is a mobile device for supporting a fast device search based on a short range communication module, the mobile device comprising: the short range communication module used for searching at least one short range communication device; and a control unit configured to restrict a communication range of the short range communication module according to a predetermined setting value of a fast device search mode.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic diagram illustrating a system in which a short range communication channel is formed in accordance with an exemplary embodiment of the present invention.

FIG. 2 is a block diagram illustrating an exemplary configuration of a mobile device in accordance with an exemplary embodiment of the present invention.

FIG. 3 is a block diagram illustrating a detailed configuration of a control unit shown in FIG. 2.

FIG. 4 is a flow diagram illustrating exemplary operation of a method for a fast device search in a mobile device in accordance with an exemplary embodiment of the present invention.

FIG. 5 is a view illustrating a screen interface of a mobile device in accordance with an exemplary embodiment of the present invention.

FIG. 6 is a view illustrating a screen interface of a short range communication device in accordance with an exemplary embodiment of the present invention.

### DETAILED DESCRIPTION

Exemplary, non-limiting embodiments of the present invention will now be described more fully with reference to the accompanying drawings. This invention may, however, be embodied in many different forms and the appended claims should not be construed as limited to the exemplary embodiments set forth herein. Rather, the disclosed exemplary embodiments are provided herein so that this disclosure will fully convey an understanding of the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring to an artisan a description of the present invention with such known techniques, elements, etc. Although the drawings represent exemplary embodiments of the invention, the drawings are not necessarily to scale and certain features may be exaggerated or omitted in order to better illustrate and explain the present invention.

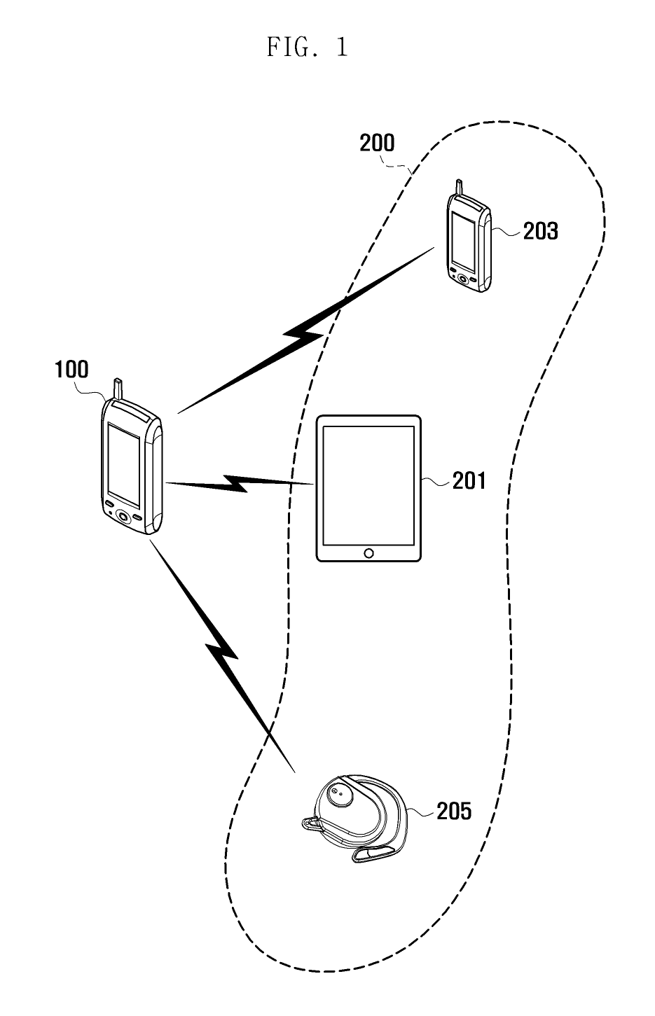

FIG. 1 is a schematic diagram illustrating a system in which a short range communication channel is formed in accordance with an exemplary embodiment of the present invention.

Referring now to FIG. 1, a system based on a short range communication channel according to an exemplary aspect of the present invention may preferably include a mobile device 100 and at least one short range communication device 200 that forms a short range communication channel with the mobile device 100. Hereinafter, the mobile device 100 will be considered as a sending device that wishes to form a short range communication channel, and the short range communication device 200 will be considered as a receiving device that transmits various response messages in response to a search request for a formation of a short range communication channel from the mobile device 100. However, this particular arrangement is exemplary only and not to be considered as limiting the presently claimed invention. The short range communication device 200 may or may not have the same configuration as the mobile device 100. Alternatively, some elements of the mobile device 100, such as a radio communication unit or a display unit, may be excluded from the short range communication device 200.

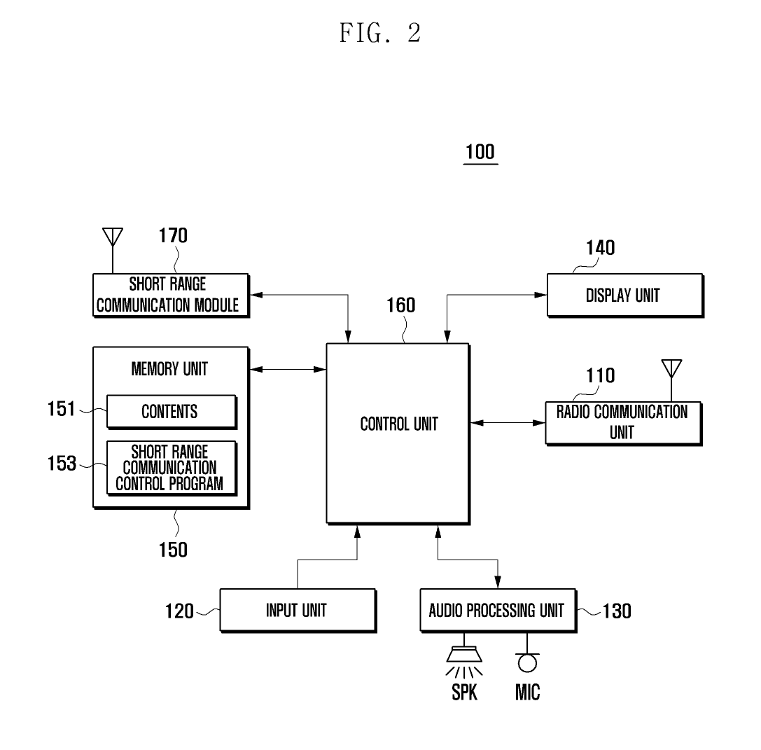

The mobile device 100 according to an exemplary embodiment of the present invention may restrict transmission power of a short range communication module (170 shown in FIG. 2), depending on a fast device search mode setting, and may perform a device search process for forming a short range communication channel on the basis of the restricted transmission power. Namely, in order to restrict the range of search for the short range communication devices 200, the mobile device 100 may restrict a short range communication range by adjusting transmission power of the short range communication module to the maximum or minimum or any other specific value depending on a setting value. Additionally, the mobile device 100 may arrange all the searched short range communication devices 200 in order of RSSI (Received Signal Strength Indicator) and then form a short range communication channel with any short range communication device 200 having the highest RSSI automatically or according to a user's selection. Therefore, the mobile device 100 may rapidly and easily establish a short range communication channel with a user's desired short range communication device 200. Meanwhile, the mobile device 100 may adjust transmission power of the short range communication module to the maximum in a process of establishing a short range communication channel with one of the searched short range communication devices 200 and in a process of sending contents. Detailed configurations and functions of the mobile device 100 will be described in more detail below with reference to FIG. 2.

The short range communication device 200 refers to a variety of devices that can form a short range communication channel with the mobile device 100. The short range communication device 200 preferably can include any mobile device 201 with a large-sized screen, any type of portable or handheld device 203, tablet, a headset 205, and the like. The short range communication device 200 may send a response message to the mobile device 100 in response to an inquiry message for search sent from the mobile device 100 and may send a device name to the mobile device 100 at the request of the mobile device 100. Additionally, the short range communication device 200 may form a short range communication channel by performing a pairing process (such as Bluetooth pairing) depending on a selection by the mobile device 100. Also, the short range communication device 200 may respond to content transmission of the mobile device 100 according to a user's input or presetting conditions and then receive and store any content transmitted. Here, a plurality of the short range communication devices 200 may selectively perform the transmission of a response message and the formation of a communication channel, depending on a separation distance from the mobile device 100 that is set in a fast device search mode. Meanwhile, the short range communication device 200 can have a display unit that outputs a screen related to a request for formation of a short range communication channel from the mobile device 100, a screen related to a request for acceptance of content transmission from the mobile device 100, a content receiving screen, and the like.

As discussed above, a network system based on a short range communication channel according to an exemplary aspect of the present invention may rapidly find a specific short range communication device and then form a short range communication channel by searching user's desired short range communication devices only through restricted transmission power of a short range communication module according to a user's setting.

FIG. 2 is a block diagram illustrating the configuration of a mobile device in accordance with an exemplary embodiment of the present invention. Hereinafter, a Bluetooth module will be used as an example of a short range communication module. The use of a Bluetooth module, however, is exemplary only and not to be considered as a limitation of the present invention. Alternatively, any other various short range communication modules such as a Zigbee module, a Near Field Communication (NFC) module, an Ultra WideBand (UWB) module, or an infrared communication module may be used.

Referring now to FIG. 2, the exemplary mobile device 100 may preferably include a radio communication unit 110, an input unit 120, an audio processing unit 130, a display unit 140, a memory unit 150, a Bluetooth module 170, and a control unit 160.

The mobile device 100 having the above elements may activate, depending on a user's input, a fast device search mode that restricts the range of search for the short range communication devices 200, and then may also restrict transmission power of the Bluetooth module 170 on the basis of the fast device search mode. Additionally, the mobile device 100 performs a search for short range communication devices, based on the restricted transmission power. Also, the mobile device 100 checks RSSI of searched-for short range communication devices 200 and then forms a short range communication channel by performing, automatically or depending on a user's control, a pairing with the short range communication device 200 having the maximum RSSI. Then the mobile device 100 may send content selected by a user to the short range communication device 200. Now, each individual element of the mobile device 100 will be described hereinbelow in more detail.

With continued reference to FIG. 2, the radio communication unit 110 establishes communication channels necessary for a voice call, a video call, data transmission, etc. under the control of the control unit 160. Namely, the radio communication unit 110 forms a voice call channel, a video call channel, a data communication channel, etc. with a mobile communication system. Additionally, the radio communication unit 110 may preferably include a radio frequency (RF) transmitter that upwardly converts the frequency of signals to be transmitted and amplifies the signals, and an RF receiver that amplifies received signals with low-noise and downwardly converts the frequency of the received signals. Also, the radio communication unit 110 may form a communication channel for receiving contents from any other mobile devices. The received contents may be delivered to the short range communication device 200 through the Bluetooth module 170. If the mobile device 100 fails to support a mobile communication function, the radio communication unit 110 may be removed from the mobile device 100 or not arranged therein.

The input unit 120 includes a plurality of input keys and function keys to receive a user's input and to set various functions. The function keys may have navigation keys, side keys, shortcut keys, and any other special keys defined to perform particular functions. Additionally, the input unit 120 may create input signals related to a user's setting or a function control of the mobile device 100 and then deliver them to the control unit 160.

More particularly, the input unit 120 may create an input signal for enabling a particular end-user function or file playback supported by the mobile device 100, an input signal for a file search, an input signal for a file selection, an input signal for searching neighboring devices through the Bluetooth module 170, and an input signal for selecting a specific neighboring device among searched short range communication devices 200, and then send such input signals to the control unit 160. Additionally, the input unit 120 may create an input signal for setting a fast device search mode that restricts the magnitude of transmission power so as to restrictively search the short range communication devices 200. Here, the fast device search mode may have several modes according to searchable ranges. For instance, if the maximum searchable range of the Bluetooth module 170 is about 10 m, the fast device search mode may include the minimum range search mode with the minimum transmission power, and the maximum range search mode with the maximum transmission power.

Alternatively, if a detailed restriction of transmission power is allowed, the fast device search mode may include a plurality of search modes that are defined with transmission power values corresponding to specific values between the minimum searchable range and the maximum searchable range.

For example, the fast device search mode may include a very short range search mode of 20 cm, a short range search mode of 1 m, a maximum short range search mode of 10 m, and the like. The input unit 120 may create an input signal for setting the above search modes at a user's request. Meanwhile, the input unit 120 may be formed of a keypad having a specific key layout, or a virtual key map in a touch screen. For instance, if the mobile device 100 employs a touch screen, the input unit 120 may create an input signal based on a touch event that occurs on a touch panel provided in the display unit 140. It is also possible that the display unit and input unit may be comprised of a single touch screen, which preferably has a portion of the touch area designated for input. The input unit may also recognize gestures, such as patterns of movement by one or more fingers across a touch screen.

The audio processing unit 130 preferably includes a speaker (SPK) for outputting various audio data received during a call, contained in a received message, or produced by a playback of an audio file stored in the memory unit 150, and a microphone (MIC) for collecting a user's voice and any other audio signals during a call. Particularly, the audio processing unit 130 may be restricted in outputting audio data according to a user's input. Namely, if a communication channel is formed between a certain audio device and the mobile device 100 through the Bluetooth module (short range communication module) 170 and also if specific audio data is transmitted to the audio device through the Bluetooth module 170, the audio processing unit 130 may block the output of audio data. Meanwhile, the audio processing unit 130 may output predefined audio data through the speaker (SPK) when the Bluetooth module 170 is enabled according to a user's input, and when a communication channel is formed with a selected short range communication device 200 after searching for neighboring devices. Alternatively, such audio data may not be outputted depending on a user's setting.

The display unit 140 represents a variety of information inputted by a user or offered to a user, including various menus of the mobile device 100. For instance, the display unit 140 may visually offer various screen views of an idle screen, a menu screen, a message writing screen, a call screen, a game screen, a music playback screen, and the like. Additionally, the display unit 140 may be formed of LCD (Liquid Crystal Display), OLED (Organic Light Emitting Diodes), or any other equivalent thin film technology. If LCD or OLED is fabricated in the form of a touch screen which could be, for example, a capacitive, resistive or surface acoustic touch screen (just to name some possibilities), the display unit 140 may act as an input unit as well. In this case, the display unit 140 may be composed of a display panel and a touch sensor(s) disposed thereon. Particularly, the display unit 140 may output a screen for selecting a fast device search mode, a screen for representing the activation of the Bluetooth module 170, a screen related to the formation of a short range communication channel through the activated Bluetooth module 170, a screen for searching contents sent through a short range communication channel, a screen for representing the transmission of selected content through a short range communication channel, and the like. A related user interface displayed on the display unit 140 will be described later.

The memory unit 150, which is a non-transient machine readable medium, stores a variety of applications required for functions related to an embodiment of this invention, including an application for a playback of various files stored and an application for operating the Bluetooth module 170. In addition, if the mobile device 100 employs a touch screen, the memory unit 150 may store a key map, a menu map, etc. required for the operation of the touch screen. Here, the key map may comprise one of various well-known types such as a keyboard map, a 3*4 key map, a qwerty key map, a Dvorak key map, or any type of special control key map suitable for the operation of a specific application in use. Also, the menu map may be a special menu map suitable for the operation of a specific application in use and may have several menu items offered by the mobile device 100. The memory unit 150 may consist of a program region and a data region.

The program region may store an operating system (OS) for booting and operating the mobile device 100, and applications required for performing various functions of the mobile device 100, such as a call application, a web browser for surfing on the Internet, a music playback application for playing digital sounds in various formats that may include but is not limited to MP3, an image viewer application for showing image files, a video player application, and the like. Particularly, the program region may store a short range communication control program 153 for operations of the Bluetooth module 170 that supports a function to search the short range communication devices 200 within a restricted range.

The short range communication control program 153 may contain a routine comprising executable code, for example, for activating the Bluetooth module 170 when an end-user function for forming a short range communication channel or an end-user function for sending a specific file through the short range communication channel is selected by a user, a routine for checking the setting conditions of a fast device search mode, a routine for searching the neighboring short range communication devices 200 on the basis of distance restrictions in the fast device search mode, a routine for forming a short range communication channel with a selected one of the searched short range communication devices 200, a routine for sending selected content to the selected short range communication device 200, and the like. In particular, the short range communication control program 153 may further contain a routine for acquiring and outputting device names of the searched short range communication devices 200, a routine for checking RSSIs of the searched short range communication devices 200 and then creating a list of RSSI sizes, and a routine for selecting a short range communication device 200 having the maximum RSSI. The artisan should understand and appreciate that some of the aforementioned functionality can be modified, combined or otherwise varied as may be desired.

The data region stores data and contents 151 that were created or received while the mobile device 100 is in operation. The contents 151 stored in the data region may be transmitted to the short range communication device 200, depending on a user's selection. In addition, if the display unit 140 is formed of a touch screen, the data region may store user's inputs received from the touch screen. Particularly, the data region may store information about the short range communication device 200 with which a short range communication channel is formed through the Bluetooth module 170. Information about the short range communication device 200 may be used as information by the control unit mobile device 100 for an automatic connection with the short range communication device 200.

The Bluetooth module 170 is representative of a short range communication module that could also operate other short range protocols other than or in addition to Bluetooth, and forms a short range communication channel with any other mobile devices and neighboring devices. Bluetooth is well-known in the art as one of a plurality of radio frequency standards for transmission of voice and data over short distances in a point to multi-point. The Bluetooth module 170 allows for a short range communication within a distance of about 10 m, or in some cases with a distance of about 100 m. Normally the Bluetooth module 170 uses the 2.4 GHz ISM (Industrial Scientific Medical) band (i.e., 2.402 GHz˜2.480 GHz) at a transmission speed of 1 Mbps with low power consumption (0.3 mA in an idle state, maximum 30 mA in transmission), while using a frequency hopping technique (79/23 hop, 1600 hop/sec) for preventing interference. Additionally, in order to prevent interference between signals, the Bluetooth module 170 may use a low-guard band of 2.4 GHz˜2.402 GHz and an up-guard band of 2.48 GHz˜2.4835 GHz. Typically, the Bluetooth module 170 may be classified into three classes according to transmission power, namely, class 1 with 100 mW, class 2 with 2.5 mW, and class 3 with 1 mW. Also, the Bluetooth module 170 uses GFSK (Gaussian Frequency Shift Keying) modulation technique and can support three-channel voices based on A-Law, u-Law PCM, and CVSD (Continuous Variable Slope Delta modulation). Particularly, when forming a communication channel with another Bluetooth module, the Bluetooth module 170 supports a selective search within ranges between 10 cm and 10 m or between 10 cm and 100 m according to setting values of the fast device search mode. Specifically, the Bluetooth module 170 may control transmission power such that an inquiry message to be used to search the short range communication devices 200 can be sent to a specific distance between transmittable minimum and maximum distances of the Bluetooth module 170 according to setting values of the fast device search mode. The by sending the inquiry message to a specific distance, between transmittable minimum and maximum distances, the claimed invention can more clearly define its search area for other devices. Then the Bluetooth module 170 may acquire device names of the short range communication devices 200 located within a communicable range based on a currently set mode value, deliver them to the control unit 160, and perform signal transmission and reception for forming a short range communication channel with a particular selected short range communication device 200 according to a user's selection or schedule information. Additionally, the Bluetooth module 170 may send the content 151 stored in the memory unit 150 through the short range communication channel according to a user's control. Meanwhile, after sending the inquiry message, the Bluetooth module 170 may maintain transmission power based on setting values of the fast device search mode or adjust the transmission power to another predefined value, e.g., the maximum transmission power value, and then may perform the acquisition of device names and the transmission of contents.

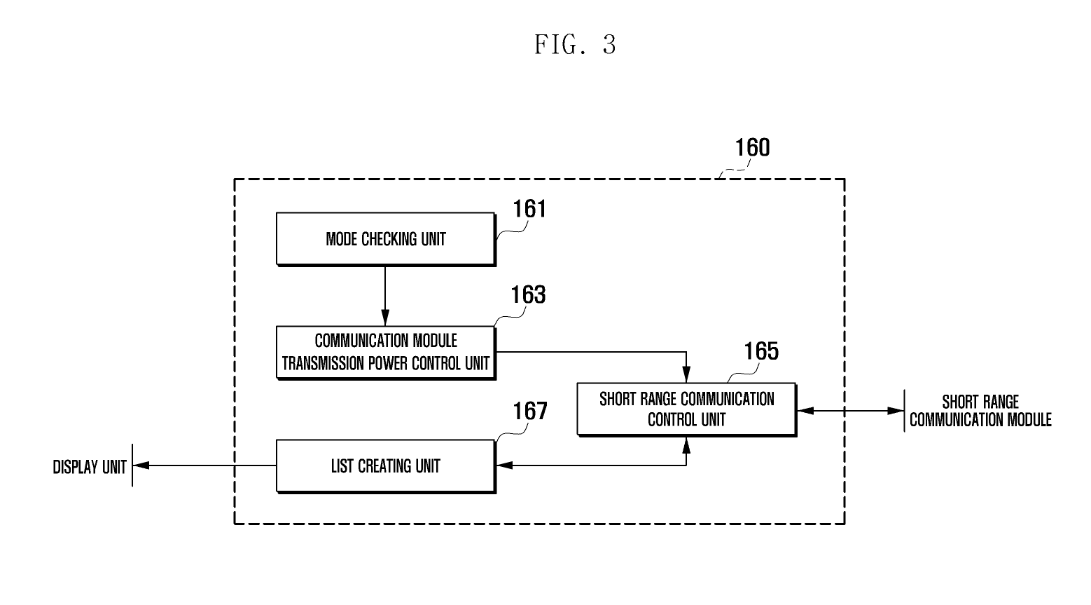

The control unit 160, which preferably includes a processor or microprocessor, controls a power supplying and initializing process for each element of the mobile device 100. After initializing, the control unit 160 may control the flow of signals such that a short range communication based on the Bluetooth module 170 may be performed. For this, the control unit 160 may include sub-components a mode checking unit 161, a communication module transmission power control unit 163, a short range communication control unit 165, and a list creating unit 167, as shown in FIG. 3.

With continued reference to FIG. 3, the mode checking unit 161 is configured to check setting conditions of the fast device search mode. Namely, the mode checking unit 161 may check a setting value of the fast device search mode of the Bluetooth module 170 from the memory unit 150. As discussed herein above, the setting value of the fast device search mode indicates a restricted distance to be used for searching for the short range communication devices 200 using the Bluetooth module 170. For instance, the setting value of the fast device search mode may have various distance values such as 10 cm or 20 cm.

The communication module transmission power control unit 163 is configured to control transmission power of the Bluetooth module 170 according to a searchable range of the Bluetooth module 170 checked by the mode check unit 161. Namely, the communication module transmission power control unit 163 adjusts a searchable range of the Bluetooth module 170 to exemplary values such as up to 10 cm, 20 cm, 1 m, etc. from the mobile device 100 by restricting transmission power of the Bluetooth module 170 according to the setting value of the fast device search mode.

The short range communication control unit 165 may control a search for the short range communication devices 200 through transmission of an inquiry message on the basis of the Bluetooth module 170 with restricted transmission power, an acquisition of a device name of the searched short range communication device 200, a formation of a communication channel with the short range communication device 200 having the acquired device name, a transmission of the content 151 selected by a user through the short range communication channel, and the like. If two or more device names of the searched short range communication devices 200 are acquired, the short range communication control unit 165 may provide the device names to the list creating unit 167. Additionally, in order to form a short range communication channel, the short range communication control unit 165 may automatically select the short range communication device 200 having the highest RSSI value in a list of the short range communication devices 200 created by the list creating unit 167.

The list creating unit 167 may create a list of device names of the short range communication device 200 acquired by the short range communication control unit 165. Additionally, the list creating unit 167 may control the display unit 140 to display the created list. In this list, the device names of the short range communication devices 200 may be arranged in order of RSSI. Namely, the device names of the short range communication devices 200 may be arranged in descending order from the highest RSSI. A person of ordinary skill in the art should appreciate that all of the units inside the box shown in FIG. 3 of the controller, and could possibly be combined or arranged differently than shown and described in the example.

As discussed above, the mobile device 100 in an exemplary embodiment of the present invention may rapidly find a user's desired short range communication device by specializing the searchable short range communication devices 200 through restricted transmission power of the Bluetooth module 170 and then by forming a communication channel with a specific short range communication device 200 having the highest RSSI among the searched short range communication devices 200.

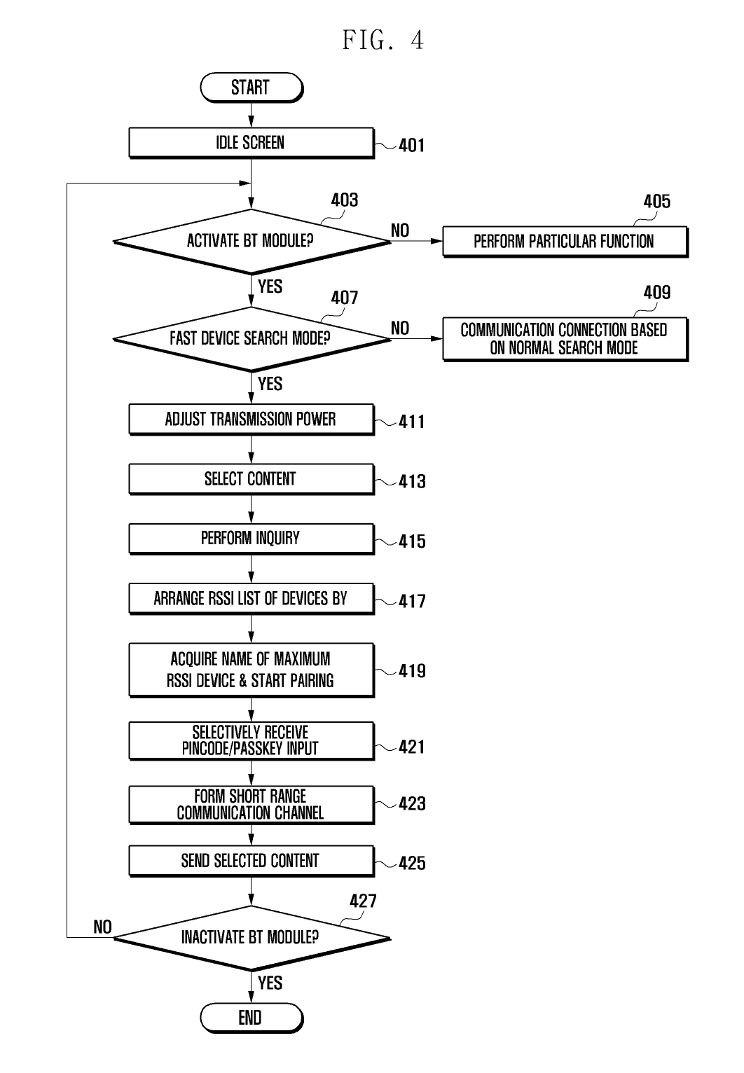

FIG. 4 is a flow diagram illustrating exemplary a method for a fast device search in a mobile device in accordance with an exemplary embodiment of the present invention that includes the illustrative examples of FIGS. 1 to 3. Referring now to FIG. 4, when power is supplied, the mobile device 100 performs a booting process and initializes the respective elements.

At (401), the mobile device 100 may output an idle screen on the display unit according to predefined schedule information.

Next at (403), the mobile device 100 may determine whether an input signal for activating the short range communication module, such as Bluetooth module 170, is received.

If there is no input signal for activating the Bluetooth module 170, then at (405) the mobile device 100 can perform a particular function in response to any other input signal. For instance, the mobile device 100 may perform a call function, a file search function, a file play function, a file transmission function, a camera function, or the like in response to a corresponding input signal.

If an input signal for activating the Bluetooth module 170 is received in the step 403, then at (407) mobile device 100 may further determine whether a current mode is a fast device search mode.

If at (407) the current mode is not a fast search device mode, then at (409) mobile device 100 may perform a communication connection based on a normal search mode. Namely, if the fast device search mode is not set, the mobile device 100 may search the short range communication devices 200 through the maximum transmission power currently set in the Bluetooth module 170 and then may perform a process of forming a short range communication channel with the searched short range communication device 200.

If at (407) a fast device search mode is currently set, then at (411) mobile device 100 may adjust the transmission power of the Bluetooth module 170 according to a setting value of the fast device search mode.

Thereafter adjusting the transmission power, at (413) when a user selects any content 151 to be sent to the short range communication device 200, then at (415) the mobile device 100 may control transmission of an inquiry message on the basis of the adjusted transmission power of the Bluetooth module 170. An artisan should appreciate and understand that step (413) can be performed at any previous step, for example, before the step (403) or between (403) and (411).

Meanwhile, at (415) when the mobile device 100 sends the inquiry message to at least one short range communication device 200 within a restricted distance according to a fast device search mode setting, the short range communication device 200 sends a response message to the mobile device in response to the inquiry message.

Then at (417) the mobile device 100 may arrange a listing of response messages based on the RSSI of the short range communication devices 200. Next at (419), the mobile device 100 may start signal transmission/reception for acquiring the device name of the short range communication device 200 with the highest RSSI and a pairing process.

In the pairing process, at (421) the mobile device 100 may selectively receive an input of “Pincode/Passkey”. Specifically, the mobile device 100 may output a popup window for an input of “Pincode/Passkey” on the display unit 140, depending on a version of the Bluetooth module 170.

If a proper input of Pincode/Passkey is received, at (423) the mobile device 100 may perform a formation of a short range communication channel. Alternatively, in case of some versions of the Bluetooth module 170, the mobile device 100 may directly perform the step (423) using previously stored device information about the short range communication device 200 without performing the step (421). In this case, the mobile device 100 may store a history about past formations of a short range communication channel with the short range communication device 200 and may skip the step (421) by using the history. After the short range communication channel is formed, at (425) the mobile device 100 may control transmission of the content 151 selected in the step 413 to the short range communication device 200.

Thereafter, at (427) the mobile device 100 may determine whether an input signal for inactivating the Bluetooth module 170 is received. If not so, the mobile device 100 may return to the step 403 and again perform the process.

Meanwhile, at (421), the short range communication device 200 may receive an input of codes used for forming a short range communication channel from the mobile device 100. Depending on a version of a Bluetooth module (or other type of short range communication module) therein, the short range communication device 200 may also perform or skip a corresponding key input process. Additionally, when a short range communication channel is formed in step (423), the short range communication device 200 may output a related message on a display unit thereof. Furthermore, when at (425) the mobile device 100 sends the content 151, the short range communication device 200 may output on the display unit 140 a popup window used for asking whether to receive the content 151. If a user agrees to receive the content 151, at (425) the short range communication device 200 may support receiving the content 151 sent from the mobile device 100.

Now, an example of a screen interface in connection with the fast device search mode of the mobile device 100 will be described. The following screen interface is, however, exemplary only and not to be considered as a limitation of this invention.

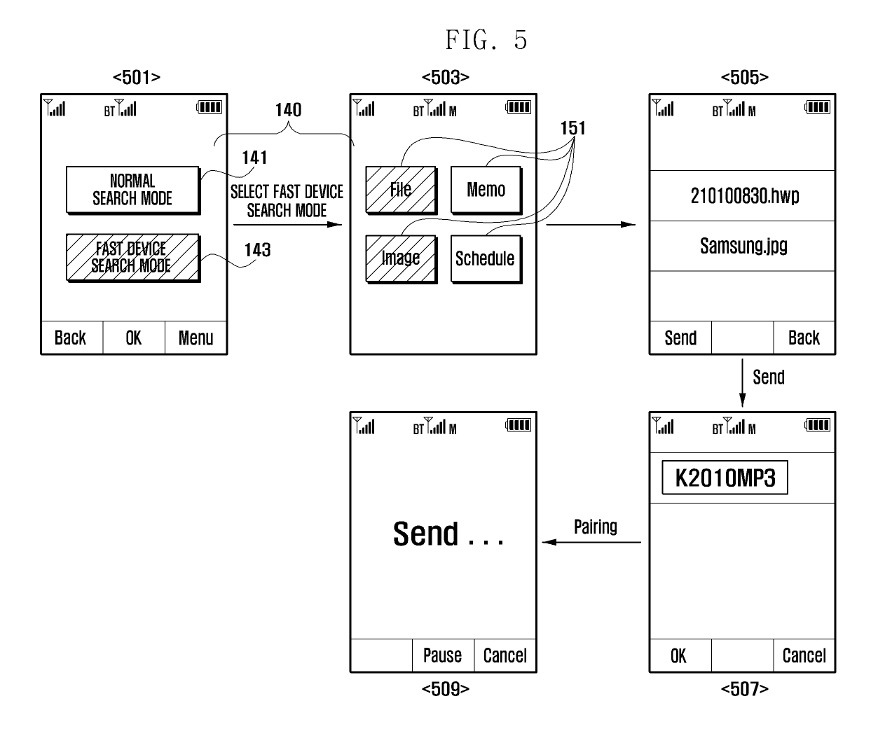

FIG. 5 is a view illustrating a screen interface of a mobile device in accordance with an exemplary embodiment of the present invention.

Referring now to FIG. 5, the mobile device 100 may output a screen 501 that allows a user the option of selecting one of a normal search mode 141 and a fast device search mode 143. In order to make this selection, a user may enter an input for activating the Bluetooth module 170 of the mobile device 100 or select desired content 151 and then enter an input for sending the selected content 151 to a specific short range communication device 200 through the Bluetooth module 170.

When at screen 501 a user selects the fast device search mode 143, the mobile device 100 may adjust transmission power of the Bluetooth module 170 according to a setting value of the fast device search mode 143. As discussed above, this setting value may include the minimum value or any other various values of transmission power of the Bluetooth module 170. If the mobile device 100 supports the minimum setting value alone of transmission power, the mobile device 100 may set the transmission power of the Bluetooth module 170 to the minimum value in response to a user's selection of the fast device search mode 143. If the mobile device 100 supports various setting values of transmission power depending on specific distances of devices 201, 203, 205, the mobile device 100 may output several items representing predetermined distances, e.g., 20 cm, 1 m, 5 m, 10 m, etc., or output an input window for allowing a user to enter a desired distance on the display unit 140, in response to a user's selection of the fast device search mode 143. The display, while preferably displaying a distance, could in fact display transmission power, or even a series of bar where the user can raise or lower transmission power, and thus the distance.

After the fast device search mode 143 is selected, the mobile device 100 may output a screen such as screen 503 that allows a user to select the content 151 to be sent to the short range communication device 200. For instance, this screen 503 may contain several selectable items such as a file, a memo, an image, and a schedule. These items outputted on the display unit 140 may be upper-level items. When a user selects at least one of them, the mobile device 100 may output lower-level items of the selected upper-level items.

When a user selects a file item and an image item in the screen 503, the mobile device 100 may output a screen such as screen 505 that represents selected contents, e.g., “210100830.hwp” and “Samsung.jpg”, on the display unit 140. Next, when a user enters an input for sending the selected contents to the short range communication device 200, for example, when a user selects a “send” key, the mobile device 100 may output a screen 507 that represents a device name of the searched short range communication device 200, for example, “K2010MP3”, on the display unit 140. In this process, the mobile device 100 may propagate an inquiry message in the air within a restricted distance according to a setting value of transmission power of the Bluetooth module 170 and then receive a response message from the short range communication device 200. If such a response message is received from a single short range communication device 200, the mobile device 100 may control signal transmission/reception for acquiring a device name of that short range communication device 200. Then the mobile device 100 may output the device name of the short range communication device 200 on the display unit 140 and, if there is no additional input for a given time or if an input signal for forming a short range communication channel is received, may automatically form a short range communication channel with the short range communication device 200. In this process, the mobile device 100 may (or may not) output a popup window for receiving Pincode/Passkey inputs dependent on particular versions of the Bluetooth module 170 as discussed above.

If response messages are received from two or more short range communication devices 200, the mobile device 100 may acquire two or more device names from the received response message and represent them in the screen 507 on the display unit 140. These device names may be arranged in the form of list in order of RSSI size. If there is no separate input, the mobile device 100 may automatically form a short range communication channel with the short range communication device 200 having the highest RSSI. If a user selects one of the short range communication devices 200, the mobile device 100 may then form a short range communication channel with the selected short range communication device 200.

Next, the mobile device 100 may control the content 151 selected in the screen 503 to be sent to the short range communication device 200. Here, the mobile device 100 may output a screen 509 that indicates transmission of the content 151 on the display unit 140.

Meanwhile, the mobile device 100 may output different indicators, depending on the normal search mode 141 or the fast device search mode 143. Therefore, a user may easily know which mode is currently selected.

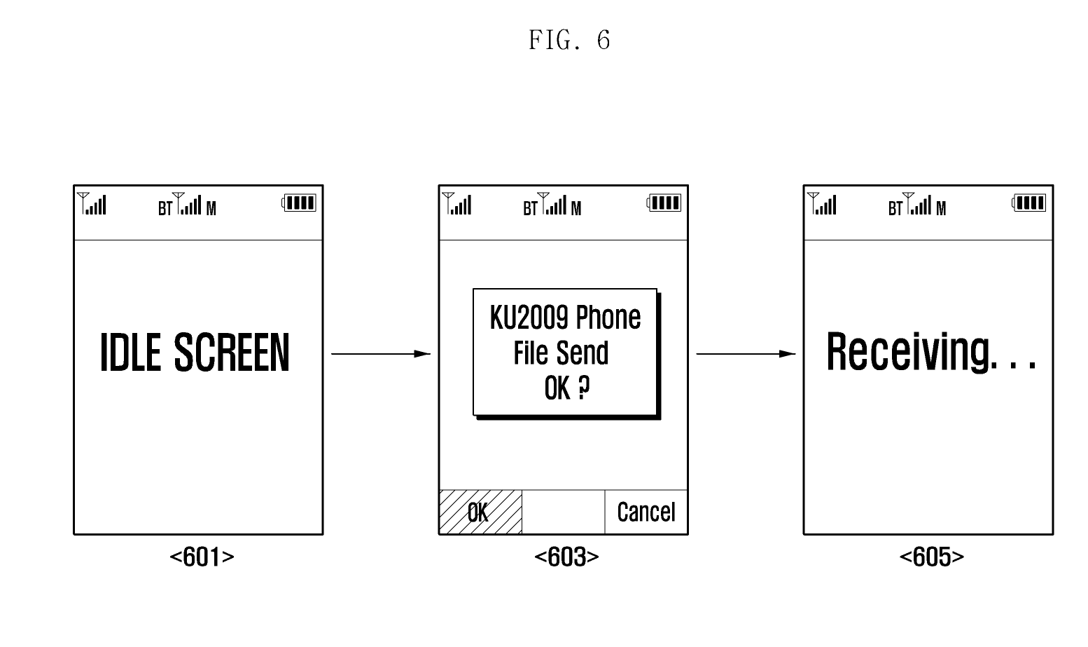

FIG. 6 is a view illustrating a screen interface of a short range communication device in accordance with an exemplary embodiment of the present invention.

Referring now to FIG. 6, the short range communication device 200 may output an idle screen 601 according to predefined schedule information. At this time, the short range communication device 200 may keep a short range communication module thereof in an activated (active) state.

The short range communication device 200 (devices 201, 203, 205) may send a response message to the mobile device 100 when receiving an inquiry message from the mobile device 100, and also may send a device name thereof to the mobile device 100 when receiving a request for a device name from the mobile device 100. Then the short range communication device 200 may send and receive signals for forming a short range communication channel with the mobile device 100. In this process, the short range communication device 200 may receive a specific key input for forming a short range communication channel, depending on a version of the Bluetooth module 170.

After a short range communication channel is formed, the short range communication device 200 may output a screen 603 that contains a popup window that prompts the user as to whether to receive the content 151 to be sent from the mobile device 100. Thereafter, if a user agrees to receive the content 151, the short range communication device 200 may output a screen 605 that indicates receiving the content 151.

The above-discussed mobile device 100 according to the present invention may essentially or selectively include any other elements. For instance, the mobile device 100 may further include a digital camera module, a wired or wireless data transmission interface, an Internet access module, a digital broadcast receiving module, and so forth. According to a digital convergence tendency today, such elements may be varied, modified and improved in various ways, and any other elements equivalent to the above elements may be additionally or alternatively equipped in the mobile device 100. Meanwhile, as will be understood by those skilled in the art, some of the above-mentioned elements in the mobile device 100 may be omitted or replaced with another.

Additionally, the mobile device 100 of this invention may include any types of electronic devices that has a WiFi module. For instance, the mobile device may include communication devices, multimedia players and their application equipment, especially including many mobile communication terminals based on various communication protocols, a portable multimedia player (PMP), a digital broadcasting player, a personal digital assistant (PDA), a music player (e.g., an MP3 player), a portable game console, a smart phone, a notebook, a handheld personal computer, etc.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for a fast device search based on a short range communication module in a mobile device, the method comprising:
determining a type of search mode set in the mobile device;
restricting by the control unit a transmission power of a short range communication module to a specific magnitude when the control unit determines that a fast device search mode has been set; and
searching by the control unit for at least one short range communication device located within a specific range determined by the restricted transmission power.

2. The method of claim 1, wherein the restricting of the transmission power to the specific magnitude when the fast device search mode has been set is determined by a setting value.

3. The method of claim 1, further comprising:
if a plurality of short range communication devices are found in response to an inquiry transmitted by the short range communication module, arranging by the control unit a list of the plurality of short range communication devices in order of a value of respectively received signal strength for each short range communication device in communication with the short range communication module of the mobile device.

4. The method of claim 3, further comprising:
automatically selecting by the control unit the short range communication device having a highest value of the received signal strength from among the plurality of short range communication devices; and
forming a short range communication channel with the selected short range communication device.

5. The method of claim 3, further comprising:
outputting a list of the arranged short range communication devices for display by a display unit or for storage by a memory.

6. The method of claim 5, further comprising:
forming a short range communication channel with at least the mobile device and the short range communication device within the specific range that has the highest value of received signal strength.

7. The method of claim 2, further comprising:
checking the setting value of the fast device search mode for a restriction on a transmission communication range of the short range communication module.

8. The method of claim 1, wherein the restricting of the transmission power includes at least one of:
restricting the transmission power of the short range communication module to the specific magnitude that comprises a minimum value corresponding to a minimum searchable range; and
restricting the transmission power of the short range communication module to the specific magnitude between the minimum value for the minimum searchable range and a maximum value corresponding to a maximum searchable range according to a setting value of a fast device search mode.

9. The method of claim 2, wherein the control unit controls the short range communication module to acquire a name of the short range communication device having the maximum received signal strength and begin a pairing operation with the short range communication device utilizing Bluetooth.

10. The method according to claim 2, wherein the short range communication module transmits via one of Zigbee, Near Field Communication, Ultra WideBand (UWB), or by infrared communication.

11. A mobile device for supporting a fast device search based on a short range communication module, the mobile device comprising:
the short range communication module including an antenna to transmit an inquiry when searching for one or more short range communication devices within a short-range communicative range; and
a control unit configured to restrict a communication range of the short range communication module from a minimum searchable range to a maximum searchable range according to a predetermined setting value of a fast device search mode.

12. The mobile device of claim 11, wherein the control unit includes:
a communication module transmission power control unit configured to restrict transmission power of the short range communication module.

13. The mobile device of claim 12, wherein the control unit further includes:
a short range communication control unit configured to search for the one or more short range communication devices on a basis of the restricted transmission power; and
a list creating unit configured to arrange, when the one or more short range communication devices comprises a plurality of short range communication devices are within communicative range of the mobile device a list of the plurality of short range communication devices arranged in order of values of a received signal strength.

14. The mobile device of claim 13, wherein the short range communication control unit is further configured to select automatically a particular short range communication device from among the plurality of communication devices having a highest value of the received signal strength and to form a short range communication channel with the selected short range communication device.

15. The mobile device of claim 13, further comprising:
a display unit configured to display an outputted list of the short range communication devices arranged in a predetermined order.

16. The mobile device of claim 12, wherein the control unit further includes:
a mode checking unit configured to determine the setting value of the fast device search mode.

17. The mobile device of claim 11, further comprising:
an input unit configured to create at least one of:
an input signal that restricts the transmission power of the short range communication module to a minimum value corresponding to a minimum searchable range for one or more short range communication devices; and
an input signal that restricts the transmission power of the short range communication module to a specific value between the minimum value corresponding to a minimum searchable range and a maximum value corresponding to a maximum searchable range according to the setting value of the fast device search mode.

18. The mobile device of claim 17, further comprising a normal search mode and the fast device search mode that are displayed by the input unit and each is selected by user contact of a specific area of the input unit.
